(19) United States
(12) Patent Application Publication
(10) Pub. No.: US 2023/0375669 A1
(43) Pub. Date: Nov. 23, 2023

(54) DESIGN FOR SENSOR AND ANTENNA FIELD OF VIEW FOR SEMI-AUTONOMOUS CTL

(71) Applicant: Caterpillar Inc., Peoria, IL (US)

(72) Inventors: Scott M. Toombs, Daly City, CA (US); Adam L. Berry, Raleigh, NC (US)

(73) Assignee: Caterpillar Inc., Peoria, IL (US)

(21) Appl. No.: 17/750,697

(22) Filed: May 23, 2022

(51) Int. Cl. G01S 7/481; H01Q 1/32; G01S 17/931; G01S 17/86; B60R 11/04

(52) U.S. Cl. CPC G01S 7/4813; H01Q 1/32; G01S 17/931; G01S 17/86; B60R 11/04

(57) ABSTRACT

A work machine can include a machine frame; a component box attached to a roof of the machine frame; a first lidar sensor located at a front corner of the component box; and a second lidar sensor located at a back corner of the component box on an opposite side of the component box than the first lidar sensor.

### TECHNICAL FIELD

This disclosure relates to construction equipment, and more specifically to a component box for a work machine.

### BACKGROUND

Work machines, such as compact track loaders can include various work tools to accomplish different construction jobs. A semi-autonomous or autonomous machine is a machine that can use a variety of sensors to detect the area around a machine so that the machine can operate without a driver or can be used to assist the driver while they operate the machine. There is a desire to provide full 360 degree sensor coverage, while also limiting the number of sensors on a machine to save costs.

WO2019197064 discusses a work machine with a guidance system including a rooftop box.

### SUMMARY

In an example according to this disclosure, a work machine can include a machine frame; a component box attached to a roof of the machine frame; a first lidar sensor located at a front corner of the component box; and a second lidar sensor located at a back corner of the component box on an opposite side of the component box than the first lidar sensor.

In another example, a work machine can include a machine frame; a component box attached to a roof of the machine frame; and five cameras coupled to the component box to provide 360 degree visual coverage; wherein the five cameras include a first camera on a front corner of the component box, a second camera on an opposite front corner of the component box from the first camera, a third camera on one side surface of the component box, a fourth camera on a second side surface of the component box, opposite the third camera, and a fifth camera at a back end of the machine frame and coupled to the component box.

In another example, a work machine can include a machine frame; a component box attached to a roof of the machine frame; a first lidar sensor located at a front corner of the component box; a second lidar sensor located at a back corner of the component box on an opposite side of the component box than the first lidar sensor; five cameras located to provide 360 degree coverage, wherein the five cameras include a first camera on a front corner of the component box, a second camera on an opposite front corner of the component box from the first camera, a third camera on one side surface of the component box, a fourth camera on a second side surface of the component box, opposite the third camera, and a fifth camera at a back end of the machine frame and coupled to the component box; and a plurality of antennas mounted to the component box including a first 2.4 GHz antenna mounted on a back end of the component box, a 900 MHz antenna positioned on a back end of the component box, a GPS receiver located on a bracket extending from the back surface of a main body of the component box, and a 2.4 GHz or 5 GHz Wi-Fi antenna located on the bracket extending from a back corner of the main body of the component box.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a perspective view of a compact track loader, in accordance with one embodiment.

FIG. 2 shows a front perspective view of a component box, in accordance with one embodiment.

FIG. 3 shows a rear, left perspective view of the component box, in accordance with one embodiment.

FIG. 4 shows a rear, right perspective view of the component box, in accordance with one embodiment.

FIG. 5 shows a schematic view of lidar sensor coverage of the present system, in accordance with one embodiment.

FIG. 6 shows a schematic view of camera coverage of the present system, in accordance with one embodiment.

### DETAILED DESCRIPTION

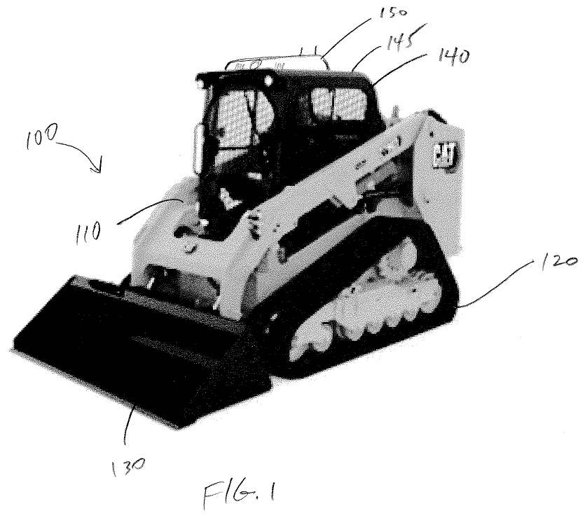

FIG. 1 shows a perspective view of a work machine 100, such as a compact track loader, in accordance with one embodiment. The work machine 100, can include a machine frame 110 with transportation devices 120 and a work implement 130 attached to the machine frame 110. Transportation devices 120 can include tracks or wheels, for example. The work implement 130 can include a bucket, forks, a shovel, a plow, or other work implement.

The machine frame 110 connects and associates the various physical and structural features that enable the work machine 100 to function. These features can include a cab 140 that is mounted on top of the machine frame 110 from which an operator can control and direct operation of the work machine 100. Accordingly, a variety of controls can be located within the cab 140. To propel the work machine 100 over a surface, a power system such as an internal combustion engine can also be mounted to the machine frame 110 and can generate power that is converted to physically move the machine.

The work machine 100 can be an autonomous or semi-autonomous machine. As such, a 3600 object detection system can be needed for autonomous vehicles. For example, lidar sensors and cameras need to be placed on the machine in specific locations to achieve a 360° field of view for object detection.

Accordingly, the present system provides a component box 150 on a roof 145 of the cab 140. The component box 150 can hold a variety of electronic equipment and sensors to allow for autonomous control. A 360 degree field of view can be established by the lidar sensors and the placement of the cameras and antennas and other components to allow for that field of view in conjunction with the base structural elements of the box

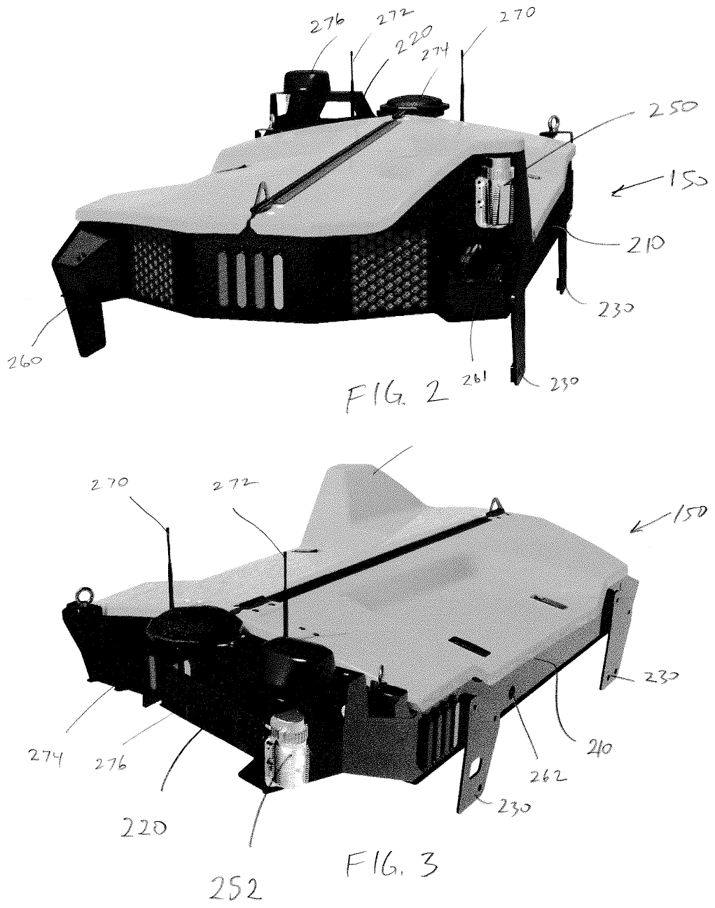

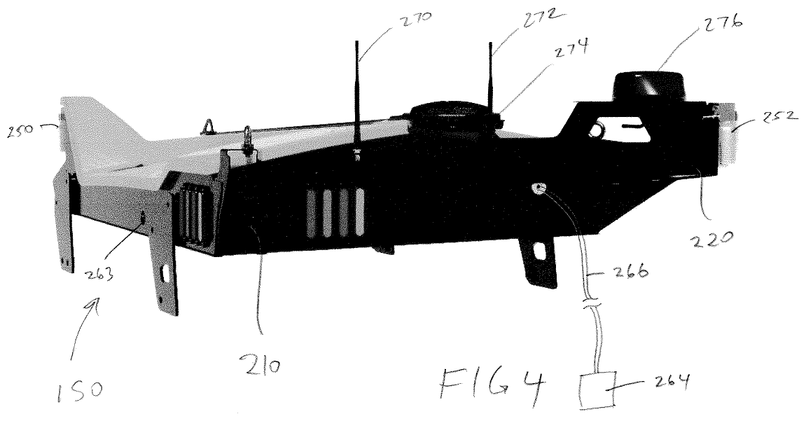

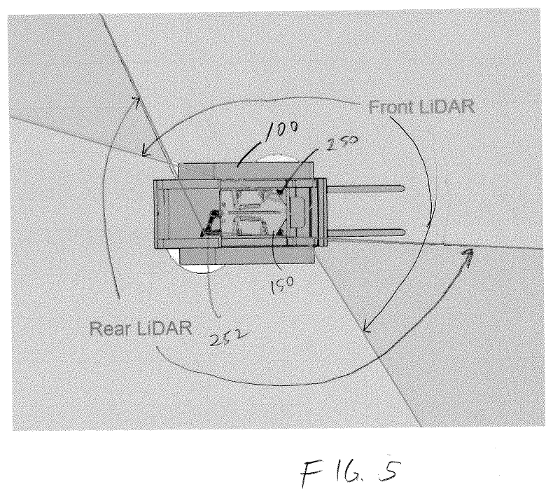

FIG. 2 shows a front perspective view of the component box 150, in accordance with one embodiment; FIG. 3 shows a rear, left perspective view of the component box 150; and FIG. 4 shows a rear, right perspective view of the component box 150.

Here, the component box 150 can generally include a main body 210 and a rear bracket 220 extending from a rear, corner surface of the main body 210. A plurality of legs 230 are used to attach the component box 150 to the work machine 100.

There can be an assortment of sensors for the components box 150. For example, a first lidar sensor 250 can be located at a front corner of the component box 150 and a second lidar sensor 252 can be located at a back corner of the component box 150 on an opposite side of the component box 150 than the first lidar sensor 250. The lidar sensors 250, 252 can be operatively attached to electronic components which are located within the component box 150 to provide 360 degree lidar coverage around an environment of the work machine.

The lidar sensors 250, 252 are placed at opposing corners of the component box 150 with the second lidar sensor 252 mounted on the bracket 220 extending from a back wall of the main body 210 of the component box 150. This design helps to minimize any interference from the component box 150 structure and from the machine frame 110 so as provide the 360 coverage while only using two lidar sensors for the component box 150. Moreover, the bracket 220 provides for minimal occlusion blockage from the structure of the work machine 100 itself by positioning the second lidar sensor 252 out far over and above the work machine.

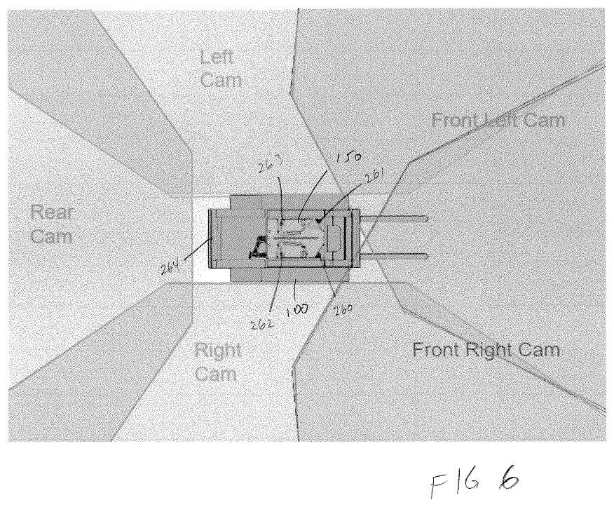

For example, FIG. 5 shows a schematic view of the lidar sensor coverage of the present system, in accordance with one embodiment. FIG. 5 shows the component box 150 on the work machine 100. Each of the lidar sensors 250, 252 can have a sensing range of at least 180 degrees and up to about 245 degrees so as to provide overlapping coverage of the environment surrounding the work machine 100. While the first and second lidar sensors 250, 252 are positioned so that there is a 360 degree lidar sensor coverage of an environment around the work machine when the work machine is unloaded, there is also increased coverage when the machine is loaded. Further, the component box 150 provides a low machine profile. This design minimizes the number of sensors needed.

Referring again to FIGS. 2-4, the sensors for the component box 150 can further include a plurality of cameras 260, 261, 262, 263, and 264 positioned to provide visual coverage of an environment around the work machine 100.

In one example, the plurality of cameras 260-264 can include five cameras located to provide 360 degree coverage. For example, the five camera can include a first camera 260 on a front corner of the component box 150, a second camera 261 on an opposite front corner of the component box 150 from the first camera 260, a third camera 262 on one side surface of the component box 150, a fourth camera 263 on a second side surface of the component box 150, opposite the third camera 262, and a fifth camera 264 that can be coupled to a back of the machine frame 110 (FIG. 1) and coupled by a wire 266 to a back end of the component box 150.

FIG. 6 shows a schematic view of camera coverage of the present system, in accordance with one embodiment. FIG. 6 illustrates camera coverage provided by the cameras 260-264. For example, each camera can have a horizontal coverage of about 120 degrees. Moreover, by providing the two front cameras 260, 261 the system allows for increased coverage and redundancy when the machine 100 is loaded since it increases the ability for the system to see during operations involving use of implements or carrying payloads.

Referring again to FIGS. 2-4, in one example, the system can further include a plurality of antennas 270, 272, 274 and 276 on the component box 150, which are arranged and positioned to avoid interference with each other and with the fields of view of the camera and lidar sensors.

In this example, the plurality of antennas can include a first 2.4 GHz or 900 MHz antenna 270 mounted on a back end of the component box 150. The first antenna 270 can be used as a line-of-site RC antenna to receive signals from a user's RC controller. The second antenna 272 can include a 900 MHz antenna positioned on a back end of the component box 150 and can be used for receiving stop functions. The second antenna 272 is spaced far enough from the first antenna 270 to eliminate or minimize any interference between the antennas 270, 271. Further, both antennas 270, 271 are stick antennas positioned to extend above the component box 150.

The third antenna 274 can include a GPS receiver located on the bracket 220 extending from a back surface of the main body 210 of the component box 150. The fourth antenna 276 can include a 2.4 GHz or 5 GHz Wi-Fi antenna located on the bracket 220 extending from a back corner of the main body 210 of the component box 150. The fourth antenna 276 is further raised on the bracket 220 to minimize or eliminate any interference from the GPS receiver, third antenna 272.

The cameras and sensors discussed above have been given specific positions and orientations relative to the component box structure to provide a particular field of view that is unobstructed by elements of the box, antennas, and other structures. They also provide overlapping fields of view. (Other details of the structure and components of the component box 150 are discussed in docket 4992.224US1, filed on an even date herewith, and incorporated by reference herein in its entirety).

### INDUSTRIAL APPLICABILITY

The present system is applicable during many situations in construction. For example, the present system can be used for compact track loaders and other work machines.

All the features discussed above can be part of the component box separately, or one or more features discussed can be combined. For example, one embodiment can include the work machine 100 having the machine frame 110, and the component box 150 attached to the roof 145 of the machine frame 110. The first lidar sensor 250 can be located at a front corner of the component box 150 and the second lidar sensor 252 can be located at a back corner of the component box 150 on an opposite side of the component box 150 than the first lidar sensor 250. The five cameras 260-264 can be located to provide 360 degree coverage, wherein the five cameras include the first camera 260 on a front corner of the component box 150, the second camera 261 on an opposite front corner of the component box 150 from the first camera 260, the third camera 262 on one side surface of the component box 150, the fourth camera 263 on a second side surface of the component box 150, opposite the third camera 262, and the fifth camera 264 at a back end of the machine frame 110 and coupled to the component box 150. The plurality of antennas mounted to the component box can include the first 2.4 GHz or 900 MHz first antenna 270 mounted on a back end of the component box 150, a 900 MHz second antenna 272 positioned on a back end of the component box 150, and spaced apart from the first antenna 270, a GPS receiver third antenna 274 located on the bracket 220 extending from the back surface of the main body 210 of the component box 150, and a 2.4 GHz or 5 GHz Wi-Fi fourth antenna 276 located on the bracket 220 extending from a back corner of the main body 210 of the component box 150.

The cameras 260-264 and lidar sensors 250, 252 have been given specific positions and orientations relative to the component box structure to provide a particular field of view that is unobstructed by elements of the component box 150, the antennas 270-276, and other structures. The cameras and lidar sensors can each provide overlapping fields of view.

In summary, the present system provides for a 360 degree field of view established by the lidar sensors and cameras and the placement of the antennas and other components to allow for that field of view in conjunction with the base structural elements of the box.

Various examples are illustrated in the figures and foregoing description. One or more features from one or more of these examples may be combined to form other examples.

The above detailed description is intended to be illustrative, and not restrictive. The scope of the disclosure should, therefore, be determined with references to the appended claims, along with the full scope of equivalents to which such claims are entitled.

What is claimed is:

1. A work machine comprising:
a machine frame;
a component box attached to a roof of the machine frame;
a first lidar sensor located at a front corner of the component box; and
a second lidar sensor located at a back corner of the component box on an opposite side of the component box than the first lidar sensor.

2. The work machine of claim 1, wherein the first and second lidar sensors are the only lidar sensors on the component box.

3. The work machine of claim 1, wherein the first and second lidar sensors are positioned so that there is a 360 degree lidar sensor coverage of an environment around the work machine when the work machine is unloaded.

4. The work machine of claim 1, further including a plurality of cameras coupled to the component box to provide visual coverage of an environment around the work machine.

5. The work machine of claim 4, wherein the plurality of cameras include five cameras located to provide 360 degree coverage.

6. The work machine of claim 5, wherein the five cameras include a first camera on a front corner of the component box, a second camera on an opposite front corner of the component box from the first camera, a third camera on one side surface of the component box, a fourth camera on a second side surface of the component box, opposite the third camera, and a fifth camera at a back end of machine frame and coupled to the component box.

7. The work machine of claim 1, wherein the second lidar sensor is mounted on bracket extending from a back wall of a main body of the component box.

8. The work machine of claim 1, further including a plurality of antennas on the component box arranged and positioned to avoid interference.

9. The work machine of claim 8, wherein the plurality of antennas includes a first 2.4 GHz antenna mounted on a back end of the component box, a 900 MHz antenna positioned on a back end of the component box, a GPS receiver located on a bracket extending from a back surface of a main body of the component box, and a 2.4 GHz or 5 GHz Wi-Fi antenna located on the bracket extending from a back corner of the main body of the component box.

10. A work machine comprising:
a machine frame;
a component box attached to a roof of the machine frame; and
five cameras coupled to the component box to provide 360 degree visual coverage;
wherein the five cameras include a first camera on a front corner of the component box, a second camera on an opposite front corner of the component box from the first camera, a third camera on one side surface of the component box, a fourth camera on a second side surface of the component box, opposite the third camera, and a fifth camera at a back end of the machine frame and coupled to the component box.

11. The work machine of claim 10, further including one or more lidar sensor on the component box.

12. The work machine of claim 11, wherein the one or more lidar sensors includes a first lidar sensor located at a front corner of the component box; and
a second lidar sensor located at a back corner of the component box on an opposite side of the component box than the first lidar sensor.

13. The work machine of claim 12, wherein the first and second lidar sensors are positioned so that there is a 360 degree lidar sensor coverage of an environment around the work machine when the work machine is unloaded.

14. The work machine of claim 13, wherein the second lidar sensor is mounted on bracket extending from a back wall of a main body of the component box.

15. The work machine of claim 10, further including a plurality of antennas on the component box arranged and positioned to avoid interference.

16. The work machine of claim 15, wherein the plurality of antennas includes a first 2.4 GHz antenna mounted on a back end of the component box, a 900 MHz antenna positioned on a back end of the component box, a GPS receiver located on a bracket extending from the back surface of a main body of the component box, and a 2.4 GHz or 5 GHz Wi-Fi antenna located on the bracket extending from a back corner of the main body of the component box.

17. A work machine comprising:
a machine frame;
a component box attached to a roof of the machine frame;
a first lidar sensor located at a front corner of the component box;
a second lidar sensor located at a back corner of the component box on an opposite side of the component box than the first lidar sensor;
five cameras located to provide 360 degree coverage, wherein the five cameras include a first camera on a front corner of the component box, a second camera on an opposite front corner of the component box from the first camera, a third camera on one side surface of the component box, a fourth camera on a second side surface of the component box, opposite the third camera, and a fifth camera at a back end of the machine frame and coupled to the component box; and
a plurality of antennas mounted to the component box including a first 2.4 GHz antenna mounted on a back end of the component box, a 900 MHz antenna positioned on a back end of the component box, a GPS receiver located on a bracket extending from the back surface of a main body of the component box, and a 2.4 GHz or 5 GHz Wi-Fi antenna located on the bracket extending from a back corner of the main body of the component box.

18. The work machine of claim 1, wherein the first and second lidar sensors are the only lidar sensors on the component box.

19. The work machine of claim 1, wherein the first and second lidar sensors are positioned so that there is a 360 degree lidar sensor coverage of an environment around the work machine when the work machine is unloaded.

20. The work machine of claim 1, wherein the second lidar sensor is mounted on bracket extending from a back wall of a main body of the component box.
